(19) United States
(12) Patent Application Publication
(10) Pub. No.: US 2009/0163611 A1
(43) Pub. Date: Jun. 25, 2009

(54) POLYMER BLEND FOR THERMOPLASTIC CELLULAR MATERIALS

(75) Inventors: Jie Li, Zofingen (CH); Horst Graeter, Muenster (DE); Mika Meller, Veikkola (FI)

Correspondence Address: ROTHWELL, FIGG, ERNST & MANBECK, P.C., 1425 K STREET, N.W., SUITE 800, WASHINGTON, DC, 20005, US

(73) Assignee: ARMACELL ENTERPRISE GMBH, Muenster (DE)

(21) Appl. No.: 12/337,836

(22) Filed: Dec. 18, 2008

(30) Foreign Application Priority Data
Dec. 19, 2007 (EP) 07024645.9

(51) Int. Cl. C08J 9/228; C08L 33/04

(52) U.S. Cl. 521/81; 521/134

(57) ABSTRACT

The present invention relates to high-temperature resistant, rigid, but flexible and low density foamed cellular material comprised of polyester blend consisting of from about 80 to about 98 weight percent of high viscosity polyethylene terephtalat (I.V.=1.0-1.9 dl/g) and from about 2 to about 20, preferably to about 5, weight percent of polycarbonate with average MW higher than 4000 g/mol.

The current invention describes foamed thermoplastic cellular products obtained by processing a polymer blend. Such foamed materials exhibit much better mechanical properties than cellular one comprised of pure homo- or copolymer resin.

The foaming processes to produce low-density PET foam products are currently mainly realized by using a tandem extrusion line (consisting of a twinscrew extruder with relatively small screw diameters as primary extruder and a single extruder with much bigger screw diameters as cooling extruder) or a twinscrew extruder and by adding physical blowing agent (CO2, N2 or HFCs etc.) and nucleation agent (Talc for instance) into PET pure resin. Different shaping tooling can be used in such processes. Despite the high-viscosity of PET raw material (I.V. mostly more than 1.2 dl/g), the mechanical properties are not satisfactory on one hand: The compression strengths of PET foams produced this way and available on market are for example not higher than 1.3 and 2.0 MPa at density of 100-110 and 150-160 kg/m³ respectively, measured in the extrusion direction. The shear elongation at break on the other hand is not bigger than 2.5% at a compression strengths 1.3 and 2.0 MPa for density of 100-110 and 150-160 kg/m³ respectively. In many applications such as construction, yacht building or wind turbine manufacturing, higher mechanical values of low-density PET foam guarantee a better performance at end use, more secure application and longer lifetime. However, more markets could be explored with tougher foams. On the other hand, a fine and homogeneous cell structure is more difficult to realize at a PET foam with low density (lower than 200 kg/m³). Low density PET foam is needed very often for insulation applications, as it provides a better thermal insulation.

The main reason for the relatively poor product properties and poor cell structure is the sensitivity of PET to thermal or thermooxidative degradation during the processing. This degradation leads to further reduction in MW and the properties of final foamed products. The high-molecular PET resin is degraded at the process because of high shearing, which contributes to higher shear stress in the extrusion line. On the other hand, the unsatisfactory mechanical values are caused partially by bigger cells in center of a PET foam product. In the all patents [1-10] or reports [11] published in the past, big size foamed PET extrudates (thickness bigger than 40 mm and width more than 100 mm) which feature better mechanical properties than mentioned above can not be produced by processing a pure polymer in the recipe or by a standard extrusion process described before up to date. An extrusion production of low density PET foam (density below 200 kg/m³) is not an easy process, particularly at a scale of industrial production.

The overall objective of this invention is to increase the mechanical values of the said PET foam products by blending PET resins and modifying the extrusion line.

Foam extrusion of polyester resins to produce low-density rigid cellular structures is a cost-effective method. The low-density cellular polyester materials made by applying physical blowing agent show many attributes of light core materials: particularly toughness, rigidity, high-temperature resistance, dimensional stability and recyclability.

One of the most cost-effective pathways to improve material performance is to use polymer blends instead of virgin polymer. The polymer blending is applied to modify the properties of one polymer by adding a second thermoplastic material. A polymer blend is defined as a mixture of two or more polymers. According to [12, 13], the term “polymer blend” is restricted to systems comprising at least 2 wt % of the second polymer. Below this level, the second phase is considered to be an additive. Usually, blending polymers is motivated to compensate for a specific weakness of a given primary material. Blend of PET/PC as compact material has been reported to have a better heat resistance [14].

In the current invention, homo- and copolyester PET were blended with PC (1-20 wt %). The PET/PC blend was fed into twinscrew extruders and mixed with CO2 or a flammable gas and nucleate to be foamed to low-density PET foam boards (ρ<200 kg/m³, measured according to ISO 845). It has been found in this invention that adding PC into PET resin increases the melt pressure in extruder first of all. This might modify positively the gas solubility and diffusion. Furthermore, the melt strength is improved and a better control of the nucleation and growth mechanisms is achieved. The foam structure of the PET/PC blend is much more homogenous due to a better strain hardening effect and an improved control of closed/open cell content in comparison with PET pure resin as raw material. The most important results of processing the PET/PC blend was surprisingly seen in the dramatic increase in rigidity (the compression strength >1.55 and 2.2 MPA at ρ=100-110 and 150-160 kg/m³ respectively, measured after extrusion according to ISO 844). In addition, the flexibility can be improved from below 2.5% to more than 3.5% (shear elongation at break according to ISO 1922). The thermal conductivity of such foamed products (foam density=100-200 kg/m³) was within the range of 0.028-0.038 W/m·K based on measurement of PET foam samples at 25° C. (according to DIN EN 12667).

Increase in melt pressure in extruder and strain hardening can also be detected if practicing a reactive extrusion of the gas-charged PET/PC blend. In this case, PET is mostly a low-viscous resin (PET regrinds or bottle grade both with I.V.≦0.8 dl/g, operating according to ASTM 4603) and the same PC grade is processed. The foam product of a PET/PC blend system which is foamed by reactive extrusion is therefore more advantageous than one of pure PET resin.

It is well-known that melt temperature over cross-section is not homogenous at the extruder exit. A cooling extruder as a dynamic mixer or a static mixer is normally used to compensate for a uniform temperature profile of melt over the cross-section. In a further study, a constellation of twinscrew extruder, melt cooler as heat exchanger and static mixer provides a much more homogenous melt system than the equipment mentioned before. Macro cells can be reduced and the mechanical properties (compression and shear strength e.g.) further improved.

In all of above described processes, a physical blowing agent may be used for foaming (often referred to as “gas”) and is typically carbon dioxide (C0₂), Nitrogen (N₂), alcohol, ketons, methylformamide, hydrofluorocarbon (for example HFC-152a or HFC-134a) or a hydrocarbon (such as n-hexane, isopentane, cyclopentane and n-heptane), or a gas mixture of above gases. The nucleate is generally talc, but alternative nucleate types can be used as well.

Beside nucleation and blowing agents, it is also possible to employ flame retardants such as halogenated, charforming or water-releasing (like phosphorus-containing) compounds and UV stabilizers in the recipes.

### EXAMPLES OF PET/PC FOAM EXTRUSIONS

The following examples are given to illustrate and not to limit the invention.

### Comparative Example 1

The extruder used in this example was BC180, a co-rotating twin-screw extruder of BC Foam with Dₘₐₓ=180 mm and Length=28D. The twin-screw extruder was attached with a static mixer and the extrusion shaping tooling consisted of a block adapter and a multihole plate. 500 kg/h of polyethylene terephthlate (PET), a PET homopolymer Cobitech 0 of MG with I.V.=1.25 dl/g (according to ASTM 4603), were fed into the extruder and foamed with help of talc as nucleate and CO₂ or a flammable gas (FG) as physical blowing agent to PET boards. The melt system flowed through the Sulzer mixer where the melt system was homogenized and cooled down to a certain temperature about 240° C. The RMP of the extruder was set to 14 (1/min.) and the throughput of PET was 500 kg/h. The foamed extrudate was pulled through a calibrator at a pull-off speed of 1.5-2.0 m/min.

The extrusion parameters are listed as following:

TABLE 01
Process parameters

| Parameter | Trial 1 | Trial 2 |
|---|---|---|
| PET flow rate (kg/h) | 500 | 500 |
| Nucleate percentage (%) | 0.2-1.0 | 0.2-1.0 |
| Gas type | CO₂ | flammable gas |
| Gas content (wt %) | 0.5-0.8 | 1.5-1.7 |
| Melt temperature Tₘ (° C.) | 240 | 237 |
| Melt pressure p_{d} (bar) | 45 | 48 |
| RPM (1/min) | 14 | 14 |
| Pulling speed (m/min) | 2.0 | 2.0 |

The melt temperature and pressure were measured at the block adapter.

The foam product could be produced, but there were a lot of macro cells (bigger than 1 mm) in middle of the boards (630×45 mm). The compression strength was measured in extrusion direction of the foam extruded sample. The shear testing was performed by shearing the sample surface which is perpendicular to the extrusion direction. The mechanical properties of foamed PET boards are demonstrated in Tab. 2:

TABLE 2
PET foam properties

| Parameter | Trial 1 | Trial 2 |
|---|---|---|
| PET foam density (kg/m³) | 156 | 114 |
| Cell structure | Macro cells visible | Macro cells visible |
| Compression strength (MPa) | 1.24 | 0.73 |
| Shear strength (MPa) | 1.0 | 0.55 |

### Comparative Example 2

The foam extrusion of comparative example 1 was repeated with the difference that a copolymer PET Cobitech 2 of MG with I.V.=1.25 dl/g (according to ASTM 4603) was processed. The process parameters were also a little different:

TABLE 3
Process parameters

| Parameter | Trial 1 | Trial 2 |
|---|---|---|
| PET throughput (kg/h) | 400 | 430 |
| Nucleate percentage (wt %) | 0.2-0.7 | 0.2-1.2 |
| Blowing agent type | CO₂ | flammable gas |
| Gas content (wt %) | 0.5-0.9 | 1.5-1.8 |
| Melt temperature Tₘ (° C.) | 239 | 240 |
| Melt pressure p_{d} (bar) | 60 | 60 |
| RPM (1/min) | 12 | 12 |
| Pulling speed (m/min) | 2.8 | 3.8 |

Because of a faster pulling speed the thickness of PET foam boards is below 30 mm after extrusion. The rigidity of PET foamed board is similar to the foam made of PET Cobitech 0:

TABLE 4
PET foam properties

| Parameter | Trial 1 | Trial 2 |
|---|---|---|
| PET foam density (kg/m³) | 147 | 112 |
| Cell structure | Macro cells visible | Macro cells visible |
| Compression strength (MPa) | 1.37 | 0.71 |

### Example 1

The foam extrusion of comparative example 1 was repeated with the difference that PC (PC Calibre™ 603-3 of Dow Chemicals: a branched polycarbonate resin and equipped with a UV stabilization package) was added to the homopolymer PET Cobitech 0. The same flammable gas was employed as physical blowing agent for a low-density foam. The PET/PC blend was fed into the twinscrew extruder. 2.7-6.0 wt % PC in PET/PC blend caused a pressure increase by about 80 bar in the extruder. The total throughput had to be dropped to 380 kg/h to reduce the melt pressure in extrusion line and keep the pressure of melt in block adapter to 65 bar:

By processing the PET/PC polymer blend the cell growth was better controlled despite more extrudate expansion. The foam extruded board exhibited a dimension of 630×55 mm. The cell structure has been more uniform and macro cells were reduced dramatically. The properties of foamed PET/PC board were able to be increased to:

TABLE 5
PET/PC foam properties

| Parameter | Value |
|---|---|
| Foam density (kg/m³) | 110 |
| Cell structure | More uniform |
| Compression strength (MPa) | >1.55 |
| Shear strength (MPa) | 0.85 |
| Shear elongation at break | >3.5% |
| Thermal conductivity at 25° C. | 0.030 |
| (W/m · K) | |

### Example 2

50 kg/h homopolymer PET Cobitech 0 of MG was mixed with 2.5-6.0 wt % PC of above grade and fed into a twinscrew co-rotating extruder LMP 90 of LMP, which was connected with a cooling/mixing unit comprising a heat exchanger section and a static mixer, followed by a multihole plate. The diameter of screw was 90 mm and the length/diameter ratio was 30D. CO₂ was used as blowing agent and 0.4-0.8 wt % talc acted as nucleate.

In comparison to pure PET resin Cobitech 0, the melt pressure of PET/PC blend was higher and a foamed material with a density of 150 kg/m³ was obtained with closed cells. The cellular structure could also be improved again. Compression strength of 2.4 MPa could be measured at the foamed PET/PC sample in extrusion direction.

### Example 3

At the extrusion line of example 2, a reactive extrusion was carried out, with the difference that a Sulzer mixer was employed this time. In this trial, 55 kg/h PET Cobitech 0 was process with and without PC of the same grade as the secondary component, but with help of a epoxy-based chain extender of Clariant, CESA Chain-Extender NCA0025531, which should be in position to stabilize or even increase the I.V. of polyester melt during extrusion process. The extruded foam board exhibited a thickness of more than 50 mm.

The recipe, process parameters and the process behavior are summarized in following table:

TABLE 6
Process parameters and process behavior

| Parameter | PET pure resin | PET/PC blend |
|---|---|---|
| PET resin | Cobitech 0 | Cobitech 0 |
| PC content (wt %) | 0 | 2.0 |
| Talc as nucleate (wt %) | 0.2-0.5 | 0.2-0.5 |
| Chain extender (wt %) | 0.5 | 0.5 |
| CO₂ as blowing agent (wt %) | 0.73 | 0.73 |
| Foam density (kg/m³) | 154 | 147 |
| Melt pressure at extruder exit (bar) | 113 | 180 |
| Melt pressure at die (bar) | 43 | 67 |

As demonstrated in Tab. 7, there was a big difference in melt pressure at extruder exit and at multihole die when processing PET/PC blend in the twinscrew extruder. The pressure increase with addition of PC in recipe indicates improvement of melt strength and a better controlled cell growth. More homogenous foam, a better foamability and better toughness/rigidity could be expected with PET/PC blend in this reactive foam extrusion.

### LITERATURE

1. Huggard M. T., U.S. Pat. No. 4,462,947 A1 (1982)
2. Huggard M. T., U.S. Pat. No. 4,466,933 A1 (1984)
3. Hayashi, M., et al, U.S. Pat. No. 5,000,991 A1 (1988)
4. Hayashi, M., et al, EP 0372846 A2 (1989)
5. Muschiatti L., U.S. Pat. No. 5,229,432 A1 (1992)
6. Al Ghatta, H., et al, U.S. Pat. No. 5,422,381 (1994)
7. EP 868 304405S (1994)
8. Al Ghatta, H., et al, EP 0866089 B1 (1994)
9. Harfmann, W. R., U.S. Pat. No. 5,681,865 A1 (1996)
10. Ishiwatari, S., U.S. Pat. No. 6,254,977 B1 (1998)
11. Lee S.-T., Foam Extrusion—Principle and Practice, Technomic Publishing C., Inc. (2000)
12. Ultracki L. A., Commercial Polymer Blends, Chapman & Hall (1998)
13. Gendon R., Thermoplastic Foam Processing—Principle and Development, CRC Press (2005)
14. Ma D. Z., et all., Compatibilizing effect of transesterification product between components in bisphenol-a polycarbonate/poly(ethylene terephtahlate) blend, J. Polym. Sci. Part B: Polym. Phys. Ed. 37, 2960 (1999)

1. High-temperature resistant, rigid, but flexible and low density foamed cellular material in form of extruded sheet or board and with a density of less than 200 kg/m³ and a thermal conductivity in range of 0.028-0.038 W/m·K comprised of PET/PC blend comprised of:
a) from about 80 to about 98 weight percent of high viscosity PET (I.V.=1.0-1.9 dl/g);
b) from about 2 to about 20 weight percent of PC with average MW higher than 4000 g/mol;
wherein physical blowing agents are applied.

2. The foamed material of claim 1 having up to about 5 weight percent of PC.

3. A foamed material comprising PET/PC blend having a PC content of up to 40 wt %, wherein PET has I.V. of 1.0-1.9 dl/g and PC features an average MW higher than 4000 g/mol.

4. A reactive extrusion foamed material obtained by foaming polyester or polyester/PC blend with help of chain extenders or grafters such as compounds with 2 or more acid anhydride or epoxy groups per molecule, wherein the polyester has I.V. from 0.2 to 1.5 dl/g and the average MW of PC is higher than 4000 g/mol.

5. Cellular articles obtained from the foamed material of claim 1.

6. Cellular articles obtained from the foamed material of claim 3.

7. Cellular articles obtained from the foamed material of claim 4.

8. A foamed material according to claim 1 having a density of 40 to 200 kg m³.

9. A foamed material according to claim 3 having a density of 40 to 200 kg/m³.

10. A foamed material according to claim 4 having a density of 40 to 200 kg/m³.

11. A foamed material according to claim 1 featuring a compression strength bigger than 1.3 MPa.

12. A foamed material according to claim 3 featuring a compression strength bigger than 1.3 MPa.

13. A foamed material according to claim 4 featuring a compression strength bigger than 1.3 MPa.

14. A foamed material according to claim 1 featuring a shear strength bigger than 0.80 MPa.

15. A foamed material according to claim 3 featuring a shear strength bigger than 0.80 MPa.

16. A foamed material according to claim 4 featuring a shear strength bigger than 0.80 MPa.

17. A foamed material according to claim 1 featuring a shear elongation at break from 3.5 to 30%.

18. A foamed material according to claim 3 featuring a shear elongation at break from 3.5 to 30%.

19. A foamed material according to claim 4 featuring a shear elongation at break from 3.5 to 30%.

20. Extrusion method for producing a foam material according to claim 1 comprising steps of:
a) feeding polymers and additives into an extruder and melting the melt system;
b) injecting and mixing a blowing agent with the molten polymer system in the extruder;
c) cooling and further homogenizing through a heat exchanger, followed by a static mixer;
d) extruding the melt mixture through a strand or flat die;
e) shaping the extrudate with help of a calibrator whose shape and dimension are fixed or adjustable; and
f) air cooling the extrudate after calibration.
